(19) United States
(12) Patent Application Publication
(10) Pub. No.: US 2010/0089546 A1
(43) Pub. Date: Apr. 15, 2010

(54) VEHICLE HEAT EXCHANGERS HAVING SHIELDING CHANNELS

(75) Inventors: Tito G. Perez, Toluca (MX); Julio A. Cortes, Toluca (MX)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/248,179

(22) Filed: Oct. 9, 2008

(51) Int. Cl. B60H 1/00; F28F 9/02; B21D 53/08

(52) U.S. Cl. 165/41; 165/173; 29/890.036

(57) ABSTRACT

A shielded heat exchanger and method of use in a vehicle is disclosed. The shielded heat exchanger may comprise a pair of spaced apart headers configured to contain a fluid flowing through the shielded heat exchanger, and a shielded tube. The shielded tube extends between the pair of headers and has a front edge. The shielded tube includes a flowing channel that operatively engages the headers for fluid flow through the flowing channel between the headers and a shielding channel extending parallel to the flowing channel between the headers along the front edge of the shielding tube, with the shielding channel configured to prevent flow of the fluid from the headers into the shielding channel.

### BACKGROUND OF INVENTION

The present invention relates generally to heat exchangers mounted near the front of a vehicle, and more particularly to protection for the heat exchangers from impacts, such as stones, hitting the front of the heat exchangers.

Heat exchangers, such as condensers and radiators, are often mounted near the front of a vehicle in order to assure adequate air flow through them. This makes them vulnerable to impacts from objects, such as stones. The impacts can break one or more of the tubes in the heat exchanger, leading to leakage of the fluid flowing through the broken tube. As a result, some vehicles (particularly off-road vehicles) include protection screens that are mounted to block objects before they can impact the heat exchanger. But implementing protection screens for the heat exchangers can cost more than is desirable and may reduce the heat exchanger performance somewhat due to a negative effect on the air pressure drop for air flowing through the heat exchanger. Others have tried to address this concern by increasing the material thickness of a flow channel along the front of heat exchanger tubes. But channels with fluid flowing in them are still exposed, so an impact that pierces the outer wall of this thicker front channel still results in leakage of the fluid flowing through the heat exchanger.

### SUMMARY OF INVENTION

An embodiment contemplates a shielded heat exchanger for use in a vehicle. The shielded heat exchanger may comprise a pair of spaced apart headers configured to contain a fluid flowing through the shielded heat exchanger, and a shielded tube. The shielded tube extends between the pair of headers and has a front edge. The shielded tube also includes a flowing channel that operatively engages the headers for fluid flow through the flowing channel between the headers, and a shielding channel extending parallel to the flowing channel between the headers along the front edge of the shielding tube, with the shielding channel configured to prevent flow of the fluid from the headers into the shielding channel.

An embodiment contemplates a method of protecting a tube of a heat exchanger mounted near a front of a vehicle from leakage due to impacts with objects, the method comprising the steps of: providing a flowing channel in the tube in fluid communication between a pair of headers, and a shielding channel extending adjacent to the flowing channel along a front of the tube; flowing a fluid through the flowing channel between the headers; and blocking any flow of fluid from the headers into the shielding channel.

An advantage of an embodiment is that the shielded heat exchanger is much less likely to suffer tube leaks due to impacts from objects, such as stones. The shielding channels can absorb the energy of a stone impact, thus shielding the flowing channels from the impact. And, it does not matter if the material of a shielding channel is pierced since it does not carry any fluid through it. The improvement in resistance to leakage due to impacts is also generally more cost effective than employing protection screens. Moreover, shielding channels can be selectively used on the tubes of the heat exchanger that are more likely to receive impacts from objects and not used on tubes that are less likely to receive impacts, thus minimizing cost and weight.

### BRIEF DESCRIPTION OF DRAWINGS

FIG. 1 is a perspective view of a portion of a shielded heat exchanger according to a first embodiment.

FIG. 2 is a view similar to FIG. 1, but taken from a different perspective.

FIG. 3 is a view similar to FIG. 1, but showing a side view.

FIG. 4 is a perspective view similar to FIG. 1, but illustrating a second embodiment.

FIG. 5 is a perspective view of the second embodiment, similar to FIG. 4, but taken from a different perspective.

FIG. 6 is a perspective view similar to FIG. 1, but illustrating a third embodiment.

FIG. 7 is a side view similar to FIG. 3, but showing the shielded heat exchanger of the third embodiment.

### DETAILED DESCRIPTION

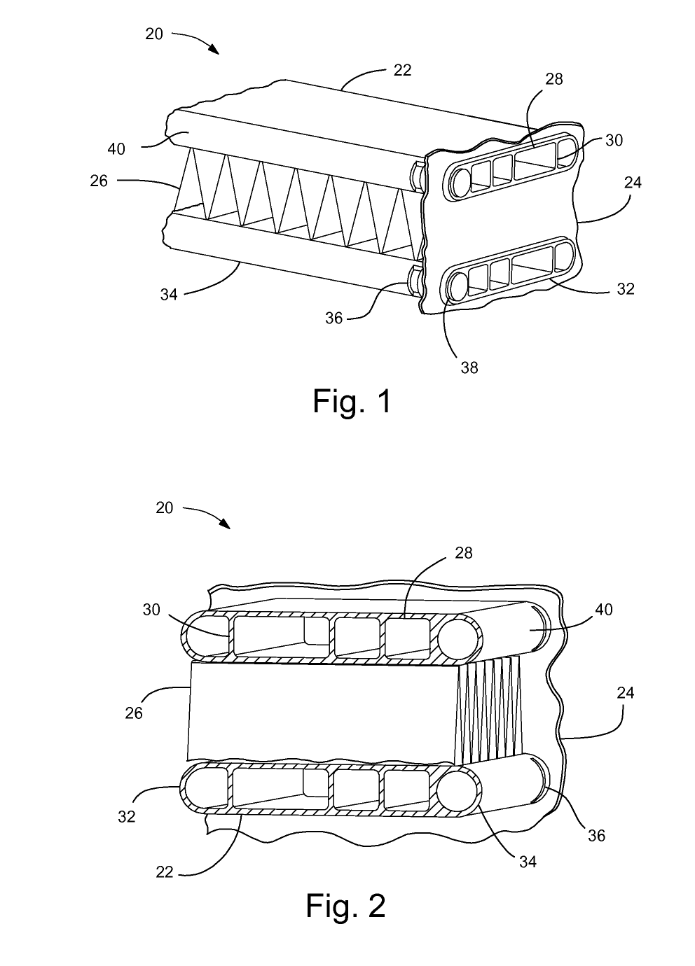

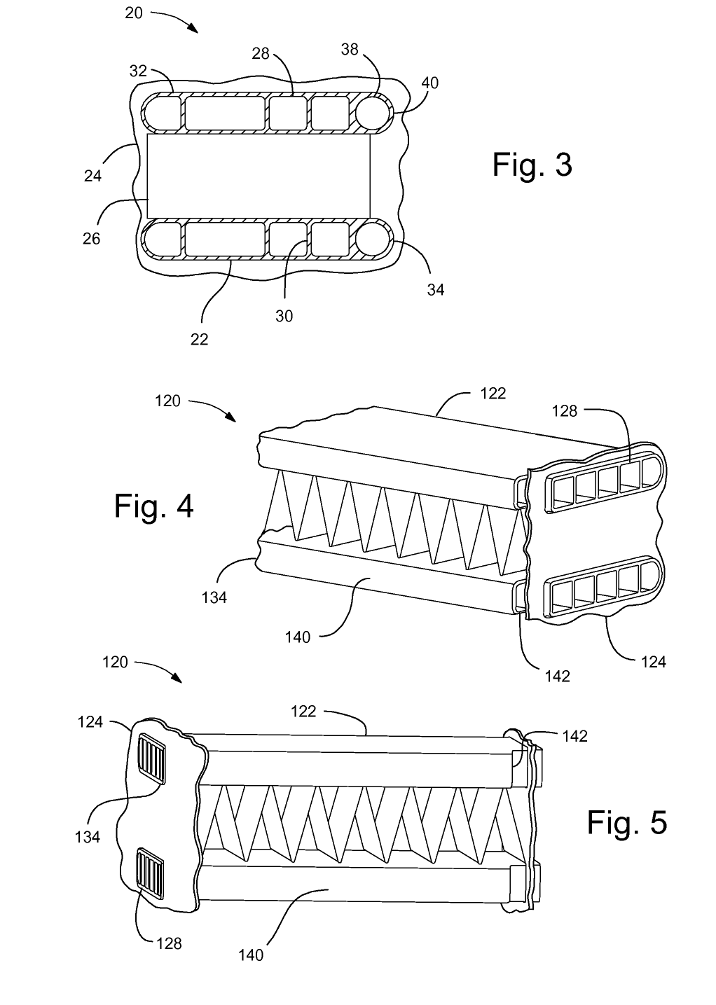

Referring to FIGS. 1-3, a portion of a shielded heat exchanger, indicated generally at 20, is shown. The shielded heat exchanger 20 may be, for example, a condenser or radiator mounted near the front of a vehicle. The shielded heat exchanger 20 includes multiple tubes 22, two of which are shown, that connect between a pair of headers 24, only one of which is shown in this embodiment. Rows of fins 26, only one row shown, are mounted between the tubes 22 and extend between the headers 24.

Each of the tubes 22 shown in FIGS. 1-3 include multiple flowing channels 28 that are defined by reinforcements 30 and an outer wall 32 of the tubes 22. The flowing channels 28 are sealed and direct fluid flow between the two headers 24. The fluid may be, for example, refrigerant or engine coolant.

Both tubes 22 shown in the first embodiment are shielded tubes—that is, the tubes 22 both also include a shielding channel 34 extending across the front 40 of the heat exchanger 20 between the headers 24. The front 40 of the heat exchanger 20 is the side of the heat exchanger 20 that will face toward the front of the vehicle in which it will be used. The shielding channels 34 are, of course, located along the front of the tubes 22 because this is the most likely location for a significant impact from an object, such as a stone, while operating the vehicle.

Each end of each shielding channel 34 includes a plug 38. The plugs 38 seal the ends to prevent fluid in the headers 24 from entering the shielding channels and leaking out of the heat exchanger 20. The plugs 38 may by made of wire with cladding on it so that the plugs 38 will be welded to the ends of the shielding channels 34 during a brazing process the heat exchanger 20 undergoes during assembly. Of course, other types of sealing means may be employed to seal the ends of the shielding channels 34 from the fluids in the headers 24 if so desired. In addition, each of the shielding channels 34 may include a cutout 36. Also, one or two of the reinforcements 30 may be eliminated (as compared to a conventional heat exchanger tube) in order to compensate somewhat for material added for the shielding channels 34.

The tubes 22 can be manufactured using conventional extrusion or folding techniques used to form tubes in conventional heat exchangers. Thus, the complexity of manufacture is not increased significantly by adding the shielding channels 34 to the tubes 22. Moreover, the shielding channels 34 can be formed integral with the flowing channels 28 of the tubes 22. The term “integral” as used herein means that the particular elements are formed as a single monolithic piece—rather than being formed separately and later assembled and secured together.

Also, if the shielding channels 34 are not additions to the original tubes for the conventional version of the heat exchanger, then one or two of the reinforcements 30 may be removed to increase the flow area in the flowing channels 28 to compensate for the loss of flow area in the shielding channels 34.

When operating the vehicle, the fluid will flow between the headers 24 through the flowing channels 28 of the tubes 22 while air flows through the fins 26. The shielding channels 34, since there is no fluid flowing in them, may act somewhat like the fins 26, drawing heat from fluid flowing in the flowing channels 28 and transferring the heat to air flowing through the heat exchanger 20. The cutouts 36, allowing for air flow into and out of the shielding channels 34, will not create a thermal shield, which may aid in the shielding channels 34 acting as fins. The distance of the shielding channels 34 in front of the fins 26 may help to reduce the fin deformation, resulting in a lower air pressure drop.

During vehicle operation, should a stone or other object impact one of the tubes 22, the impact will be with the shielding channel 34 since it extends across the front of the tube 22. The shielding channel 34, then, will absorb the energy of the impact. Since the fluid of the heat exchanger 20 does not flow through the shielding channel 34, even if the impact pierces the shielding channel 34, there will be no fluid leakage from the heat exchanger 20. Consequently, this shielding channel 34 will act as a shield to protect the tube 22 right where and only where it is needed. In addition, the cutouts 36 can be employed to inspect the shielding channels 34 to assure that there is no leakage through the plugs 38 into the shielding channels 34.

FIGS. 4-5 illustrate a second embodiment of the shielded heat exchanger 120. Since this embodiment is similar to the first, similar element numbers will be used for similar elements, but employing 100-series numbers.

In this embodiment, the shielding channels 134 at the front 140 of each tube 122 extend almost all of the way across between the headers 124, but stop just short, at open channel ends 142. Thus, while the flowing channels 128 still extend to and direct fluid between the headers 124, the shielding channels 134 do not contact or extend into the headers 124. With this configuration, no brazing or other means of sealing needs to take place to assure that fluids do not leak from the headers 124 into the shielding channels 134.

In addition, the cross sectional shape of the shielding channels 134 can be whatever is desirable to provide the most advantageous combination of ability to absorb impact energy while minimizing manufacturing costs. This flexibility in cross sectional shape is applicable for other embodiments as well.

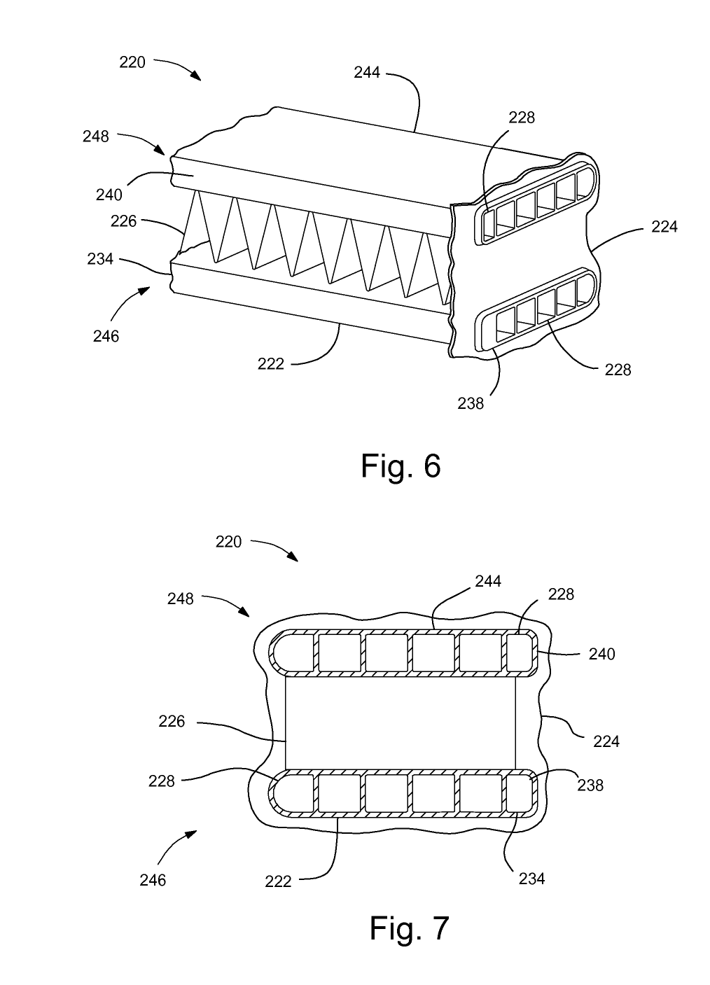

FIGS. 6-7 illustrate a third embodiment of the shielded heat exchanger 220. Since this embodiment is similar to the first, similar element numbers will be used for similar elements, but employing 200-series numbers.

In this embodiment, one of the tubes is a shielded tube 222 while the other tube is a non-shielded tube 244, with of course a row of fins 226 between them. Thus, there may be a zone 246 of shielded tubes 222 and a zone 248 of non-shielded tubes 244. This illustrates that not all of the tubes need to be shielded tubes. It may be preferable for a particular vehicle application to have only a few of the lowest tubes on the heat exchanger be shielded to provide protection from projectiles while the upper tubes are non-shielded to save weight and cost. Of course, this is applicable to the other embodiments as well.

For the shielded tube 222, the flowing channels 228 are open to the headers 224 while the shielding channel 234 has welded ends 238 that block fluid flow into this channel 234. For the non-shielded tube 244, the channel along the front 240 of the tube 244 is a flowing channel 228 with a fluid connection to the headers 224 like the other flowing channels 228. This channel along the front of the non-shielded tube 244 may be an additional channel, with the non-shielded tube having the same number of channels as a shielded tube, or there may be one less channel for the non-shielded tube if so desired.

The shielding channel 234 in this embodiment is sealed, with no cutouts or open channel ends like the first two embodiments. Thus, air is trapped in the shielding channel 234. As the trapped air heats up during operation of the vehicle, this hot air may build pressure that will help absorb the energy of impact from objects, such as stones.

While certain embodiments of the present invention have been described in detail, those familiar with the art to which this invention relates will recognize various alternative designs and embodiments for practicing the invention as defined by the following claims.

What is claimed is:

1. A shielded heat exchanger for use in a vehicle comprising:
a pair of spaced apart headers configured to contain a fluid flowing through the shielded heat exchanger; and
a shielded tube extending between the pair of headers and having a front edge, the shielded tube including a flowing channel that operatively engages the headers for fluid flow through the flowing channel between the headers, and a shielding channel extending parallel to the flowing channel between the headers along the front edge of the shielding tube, the shielding channel configured to prevent flow of the fluid from the headers into the shielding channel.

2. The shielded heat exchanger of claim 1 wherein the shielding channel and the flowing channel are integral portions of the shielded tube.

3. The shielded heat exchanger of claim 1 wherein the shielding channel is sealed to trap air inside.

4. The shielded heat exchanger of claim 1 wherein the shielding channel has a cutout to allow for air flow into and out of the shielding channel.

5. The shielded heat exchanger of claim 1 wherein the shielding channel has open channel ends that are adjacent to but do not contact the headers.

6. The shielded heat exchanger of claim 1 wherein the shielding channel includes a plug at each end of the shielding channel located in the headers, and wherein the plugs are welded to the ends of the shielding channel.

7. The shielded heat exchanger of claim 1 including a second tube spaced from and extending between the headers parallel to the shielded tube, and a set of fins located between the shielded tube and the second tube and extending between the headers, wherein the second tube includes a second flowing channel that operatively engages the headers for fluid flow through the second flowing channel between the headers.

8. The shielded heat exchanger of claim 7 wherein the second tube is a second shielded tube that includes a second shielding channel extending parallel to the second flowing channel between the headers along a front edge of the second shielded tube, the second shielding channel configured to prevent fluid flow from the headers into the shielding channel.

9. The shielded heat exchanger of claim 7 wherein the second tube is a non-shielded tube that includes a third flowing channel extending parallel to the second flowing channel between the headers along a front edge of the non-shielded tube, the third flowing channel operatively engaging the headers for fluid flow through the third flowing channel between the headers.

10. The shielded heat exchanger of claim 1 wherein the shielded heat exchanger is a condenser and the fluid is a refrigerant.

11. A method of protecting a tube of a heat exchanger mounted near a front of a vehicle from leakage due to impacts with objects, the method comprising the steps of:
(a) providing a flowing channel in the tube in fluid communication between a pair of headers, and a shielding channel extending adjacent to the flowing channel along a front of the tube;
(b) flowing a fluid through the flowing channel between the headers; and
(c) blocking any flow of fluid from the headers into the shielding channel.

12. The method of claim 11 including (d) absorbing the impact of the object at the front of the tube by deforming the shielding channel.

13. The method of claim 11 wherein step (a) is further defined by the shielding channel including a cutout, and including step (d) allowing free flow of air into and out of the shielding channel.
